(19) United States
(12) Patent Application Publication
(10) Pub. No.: US 2013/0057953 A1
(43) Pub. Date: Mar. 7, 2013

(54) NONLINEAR OPTICAL MICROSCOPE

(71) Applicant: Eiji YOKOI, Tokyo (JP)

(72) Inventor: Eiji YOKOI, Tokyo (JP)

(73) Assignee: OLYMPUS CORPORATION, Tokyo (JP)

(21) Appl. No.: 13/595,190

(22) Filed: Aug. 27, 2012

(30) Foreign Application Priority Data
Sep. 2, 2011 (JP) 2011-191632

(51) Int. Cl. G02B 21/06

(52) U.S. Cl. 359/388

(57) ABSTRACT

A nonlinear optical microscope includes: a light source unit emitting pulsed light having a wavelength of 1200 nm or more and having a pulse width of several tens through several hundreds of femtoseconds; an objective emitting the pulsed light from the light source unit to a sample and having a working distance of 2 mm or more; and an immersion liquid filling the space between the sample and the objective and having an internal transmittance higher than an internal transmittance of pure water with respect to the wavelength of the pulsed light emitted from the light source unit.

### CROSS REFERENCE TO RELATED APPLICATIONS

This application is based upon and claims the benefit of priority from Japanese Patent Application No. 2011-191632, filed Sep. 2, 2011, the entire contents of which are incorporated herein by this reference.

### BACKGROUND OF THE INVENTION

1. Field of the Invention

The present invention relates to a nonlinear optical microscope.

2. Description of the Related Art

In observing a biological sample using a nonlinear optical microscope, the largest factor in restricting the observation depth is the scattering of light on the sample. For example, in a fluorescent observation using a two-photon excitation microscope, the scattering of excitation light causes a decrease in the excitation light that enters into a focal plane, a reduced S/N ratio due to the scattered light, and the like, thereby restricting the observation of the deep portion of the sample. Furthermore, the scattering of fluorescence causes a decrease in the fluorescence that enters an image pickup device, and restricts the observation of the deep portion of the sample.

Therefore, the most popular approach for observing the deep portion of a biological sample is to use a longer wavelength of light, which is effective in suppressing the scattering.

On the other hand, the observation depth is also restricted by the absorption of light in addition to the scattering of light. For example, water, which is a dominant component of a biological sample, has a low light transmittance in the long wavelength band. The greater the observation depth, the greater the distance passed by light in the biological sample. Therefore, when the deep portion of the sample is observed, the influence of the absorption of light by the water in a biological sample cannot be ignored.

Accordingly, the observation depth does not necessarily become greater as the wavelength of light gets greater; it depends on the balance between the scattering of light and the absorption of light.

From the viewpoint of the above, a microscope obtained by considering the balance between the scattering of light and the absorption of light and using the light in a wavelength band in which the absorption of light can be relatively suppressed at a long wavelength is disclosed by, for example, non-patent document D. Kobat et al. (D. Kobat, M. E. Durst, N. Nishimura, A. W. Wong, C. B. Schaffer; C. Xu: “Deep tissue multiphoton microscopy using longer wavelength excitation,” Optics Express, Vol.17 No 16 (2009), 13354-13364.)

According to the microscope disclosed by non-patent document D. Kobat et al., since the excessive absorption of light by water can be suppressed using the long-wavelength light, which is capable of suppressing the scattering of light, a biological sample can be observed to a deeper portion.

The absorption of light does not occur only in a biological sample, but can occur at any point in the optical path. For example, in a nonlinear optical microscope such as a two-photon excitation microscope or the like, a liquid immersion technique is often used to improve the numerical aperture by filling the space between an objective and a sample with an immersion liquid, but the absorption of light by an immersion liquid as well as the absorption of light on a sample can cause a restriction on the observation depth.

In the observation of a biological sample, it is common to use pure water (water) as an immersion liquid because the difference in refractive index between an immersion liquid and a sample can in many cases be smaller, and the water can be easy to handle. For the microscope disclosed by non-patent document D. Kabat et al., pure water is used as an immersion liquid.

### SUMMARY OF THE INVENTION

An aspect of the present invention provides a nonlinear optical microscope including: a light source unit emitting pulsed light having a wavelength of 1200 nm or more and a pulse width of several tens through several hundreds of femtoseconds; an objective emitting the pulsed light from the light source unit to a sample and having a working distance of 2 mm or more; and an immersion liquid filling the space between the sample and the objective and having an internal transmittance higher than an internal transmittance of pure water with respect to the wavelength of the pulsed light emitted from the light source unit.

### BRIEF DESCRIPTION OF THE DRAWINGS

The present invention will be more apparent from the following detailed description when the accompanying drawings are referenced.

FIG. 1 is an explanatory view of the two-photon excitation microscope according to embodiment 1;

FIG. 2 illustrates the transmittance characteristic of an immersion liquid;

FIG. 3 is an explanatory view of the relationship between the refractive index of an immersion liquid and the actual distance in the immersion liquid; and

FIG. 4 is an explanatory view of the two-photon excitation microscope according to embodiment 2.

### Description of the Preferred Embodiments

### Embodiment 1

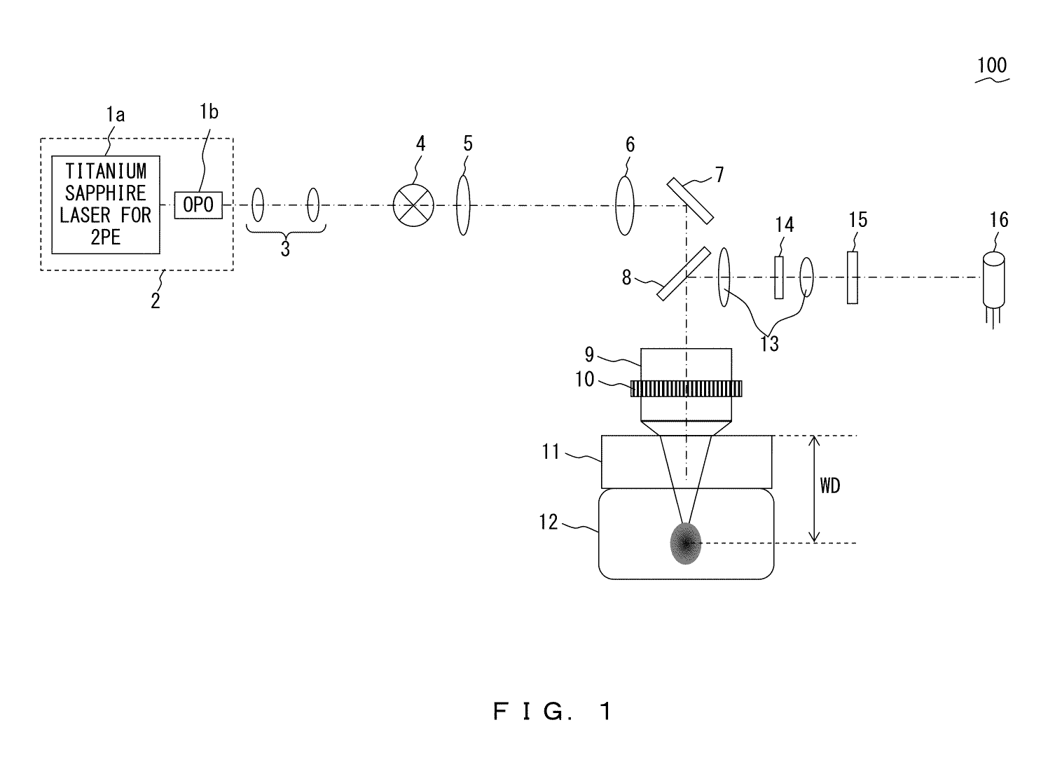

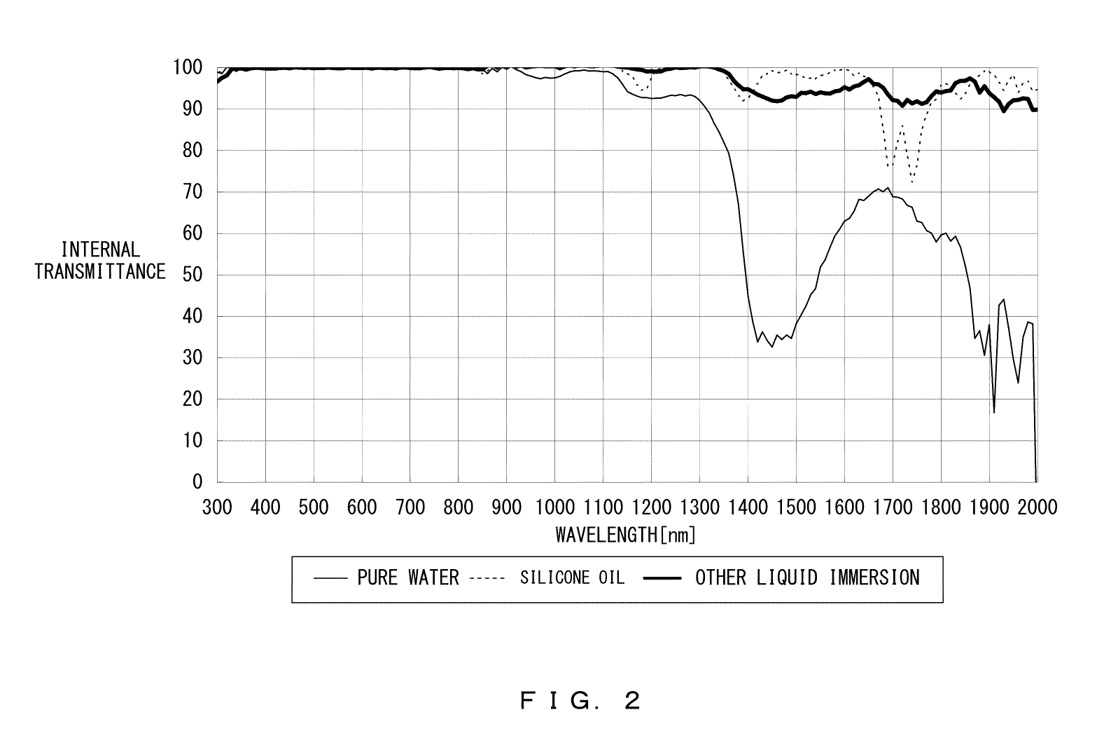

FIG. 1 is an explanatory view of the two-photon excitation microscope according to the present embodiment. FIG. 2 illustrates the transmittance characteristic of an immersion liquid, and the horizontal axis indicates a wavelength (nm) and the vertical axis indicates the internal transmittance (%) per unit length (1 mm).

A two-photon excitation microscope 100 as a type of nonlinear optical microscope exemplified in FIG. 1 includes: a light source unit 2 configured by a titanium sapphire laser 1a and an optical parametric oscillator 1b (hereafter referred to as an OPO); a beam expander 3 for expanding a beam diameter; a galvanometer mirror 4 for scanning a sample 12; a pupil relay lens 5; a tube lens 6; a mirror 7; a dichroic mirror 8 for reflecting fluorescence generated from the sample 12 and for allowing laser light which excites the sample 12 to pass through; an objective 9 for emitting the laser light emitted from the light source unit 2 to the sample 12; and a silicone oil 11 as an immersion liquid filling the space between the sample 12 and the objective 9.

Furthermore, as illustrated in FIG. 1, the two-photon excitation microscope 100 includes on the reflective optical path of the dichroic mirror 8 a relay lens 13, an IR (infrared ray) cut filter 14, a reactive light detection filter 15, and a photomultiplier 16 (hereafter referred to as a PMT) as a photodetector for detecting fluorescence.

The titanium sapphire laser 1a emits pulsed light having a pulse width on a subpicosecond order, and the OPO 1b converts the wavelength of the pulsed light emitted from the titanium sapphire laser 1a into a wavelength of 1200 nm or more. That is, the light source unit 2 has emits laser light having a wavelength of 1200 nm or more and, for example, having a pulse width on the subpicosecond order of some tens through some hundreds of femtoseconds as pulsed light.

The beam expander 3 expands the beam diameter of the laser light emitted from the light source unit 2, and emits it as a parallel luminous flux. The galvanometer mirror 4 is arranged at a position optically conjugate to the pupil position of the objective 9. That is, the two-photon excitation microscope 100 forms an image of the galvanometer mirror 4 at the pupil position of the objective 9 by the pupil relay lens 5 and the tube lens 6. Therefore, the galvanometer mirror 4 deflects the parallel luminous flux from the beam expander 3, thereby changing the tilt of the parallel luminous flux entering the objective 9 with respect to the optical axis, and scanning the sample 12.

The objective 9 has a working distance of 2 mm or more, and is provided with a correction ring 10 as a spherical aberration correction mechanism. The correction ring 10 is used to correct the spherical aberration caused by the inconsistency of the refractive index between the silicone oil 11 and the sample 12, and the spherical aberration caused by a change in observation depth. It is desired that the objective 9 be designed to appropriately correct the aberration for a wavelength band of 1200 nm or more, that is, in practical terms, for the wavelength band from 1200 nm to 1850 nm. In the wavelength band for which the aberration is not appropriately corrected, the correction ring 10 can correct the spherical aberration.

The silicone oil 11 has a refractive index of about 1.4, which is higher than the refractive index (1.33) of pure water, and has an internal transmittance higher than that of pure water for the wavelength (1200 nm or more) of the laser light (pulsed light) emitted from the light source unit 2, as illustrated in FIG. 2.

In FIG. 1, the silicone oil 11 is exemplified as an immersion liquid, but the immersion liquid is not limited to the silicone oil 11. For example, the silicone oil 11 can be replaced with an immersion liquid (mere commercially available immersion liquid) used for a water-immersion microscope, including perfluoropolyether, which has a commercially available functional group. The refractive index of the commercially available immersion liquid is closer to the refractive index of pure water than the silicone oil 11, but as illustrated in FIG. 2, both the silicone oil 11 and the commercially available immersion liquid have an internal transmittance higher than that of pure water in the long wavelength band exceeding 1200 nm.

The IR cut filter 14 cuts off the light having a wavelength in the infrared region, which is used to prevent the laser light emitted from the light source unit 2 from entering the PMT 16. The reactive light detection filter 15 is used to detect, using the PMT 16, only the fluorescence (reactive light) of a specific wavelength determined by the fluorescent molecule of the sample 12.

The PMT 16 is arranged near a position optically conjugate to the pupil position of the objective 9. By the relay lens 13 projecting the pupil of the objective 9 to near the PMT 16, the two-photon excitation microscope 100 can detect the fluorescence, which can be generated in any area of the sample 12, by scanning the sample 12.

Since the two-photon excitation microscope 100 configured as described above emits light of a long wavelength of 1200 nm or more on the sample 12 by the objective 9, the scattering of light caused on the sample 12 can be suppressed.

Furthermore, the two-photon excitation microscope 100 is provided with the objective 9 having a working distance of 2 mm or more to observe the deep portions. Therefore, the amount of the immersion liquid used for the observation necessarily increases. However, since the silicone oil 11 having an internal transmittance higher than that of the pure water is used in the two-photon excitation microscope 100, the absorption of light between the objective 9 and the sample 12 can be suppressed.

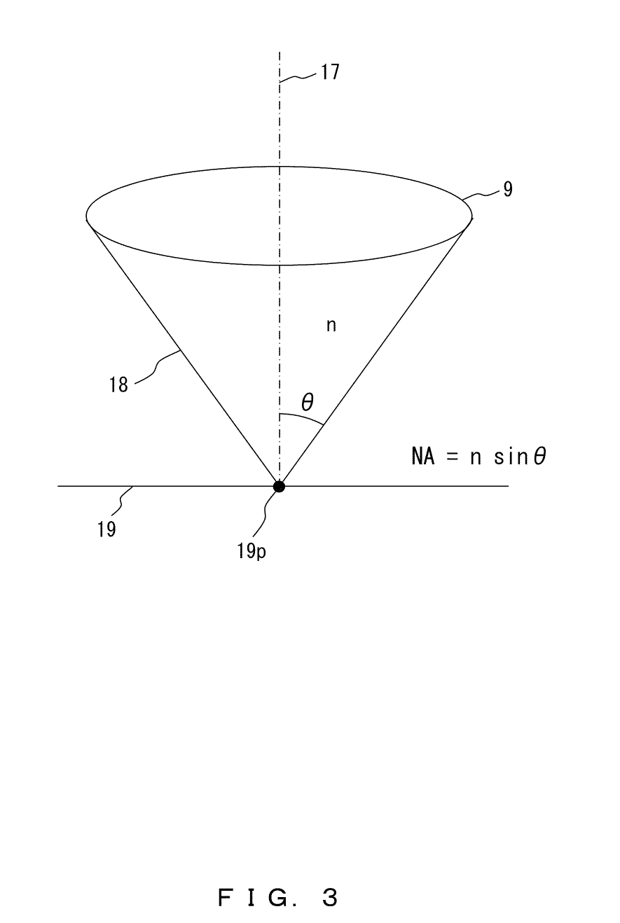

As illustrated in FIG. 3, when the same numerical aperture (NA) is realized, the higher the refractive index n of the medium between the objective 9 and the focal plane 19 is, the smaller the angle θ (hereafter referred to as the maximum incident angle) between the light 18 entering an optical axis 17 with the maximum angle and the optical axis 17 becomes. That is, with the two-photon excitation microscope 100 using the silicone oil 11 having a refractive index higher than that of pure water as an immersion liquid, the maximum incident angle θ can be smaller than when pure water is used. The smaller the maximum incident angle θ is, the shorter the distance from the point where the light 18 entering at the maximum incident angle is emitted from the objective 9 to the point where the light enters a focal position 19p becomes. Therefore, the two-photon excitation microscope 100 can further suppress the absorption of light by the immersion liquid. To acquire the effect, it is necessary for the immersion liquid to have a somewhat larger refractive index than pure water. Accordingly, it is preferable that the refractive index of the immersion liquid be larger than 1.38.

For the reason described above, the two-photon excitation microscope 100 according to the present embodiment can suppress the absorption of light even though light of a long wavelength is used to suppress the scattering. Therefore, the microscope according to the present invention can observe a deeper part of a sample than a conventional microscope.

With a nonlinear optical microscope which causes a nonlinear optical phenomenon using pulsed light of a very short pulse width (for example, on a subpicosecond order), a very high photon density is required on a focal plane. Therefore, the configuration realized by the two-photon excitation microscope 100 according to the present embodiment that is capable of suppressing the absorption of light even when light of a long wavelength is used is specifically preferable in a nonlinear optical microscope.

FIG. 1 exemplifies a two-photon excitation microscope in nonlinear optical microscopes, but the microscope according to the present embodiment is not limited to a two-photon excitation microscope. For example, the nonlinear optical microscope can be a multiphoton excitation microscope, a second harmonic generation (SHG) microscope, a third harmonic generation (THG) microscope, a coherent anti-Stokes Raman scattering (CARS) microscope, and the like. In this case, the reactive light detection filter 15 can be an optical filter using a wavelength characteristic depending on the reactive light. For example, in the case of the SHG microscope, the reactive light detection filter 15 passes ½ wavelength of the light source wavelength (excitation wavelength). In the case of the THG microscope, the reactive light detection filter 15 passes ⅓ wavelength of the light source wavelength (excitation wavelength).

A further preferable configuration of the two-photon excitation microscope 100 according to the present embodiment is described below concretely.

The two-photon excitation microscope 100 above can suppress the absorption of light by an immersion liquid by using the silicone oil 11 as an immersion liquid instead of pure water. As a result, a sample can be observed to a deeper portion. Thus, the absorption of light by the immersion liquid is considered in the two-photon excitation microscope 100 above. When the observation depth is large, the influence of the absorption of light by the water in the sample also becomes large. Therefore, in addition to the absorption of light by the immersion liquid, it is also preferable that the absorption of light by the water in the sample can also be suppressed.

As illustrated in FIG. 2, the internal transmittance of pure water suddenly drops at about the point where the wavelength exceeds 1350 nm, and becomes low around a wavelength of 1400 nm through 1500 nm. Then, the transmittance temporarily reverses, and indicates a relatively high internal transmittance with respect to the wavelengths between 1500 nm through 1850 nm. Subsequently, the band indicating a low internal transmittance is referred to as a reflection band, and the band indicating a relatively high internal transmittance is referred to as a transmission band. The transmission band has a maximum point of internal transmittance between 1600 nm and 1750 nm.

Therefore, it is preferable that the two-photon excitation microscope 100 be configured so that the wavelength of the pulsed light emitted from the light source unit 2 is in the range from 1500 nm to 1850 nm, where the transmission band is formed. Thus, even if the light of a long wavelength is used, the absorption of light by both an immersion liquid and the water in a sample can be suppressed. Therefore, the deep portion of a sample can be observed. Even more preferable is to have the two-photon excitation microscope 100 configured so that the wavelength of the pulsed light emitted from the light source unit 2 is 1600 nm through 1750 nm, where the internal transmittance, including the maximum point of the internal transmittance of pure water, refers to a higher band, and the internal transmittance of the immersion liquid is 80%/mm or more with respect to the wavelength of the pulsed light. Thus, the absorption of light by both an immersion liquid and the water in a sample can be further suppressed, thereby enabling observation of deeper portions of the sample.

Alternately, it is preferable that the two-photon excitation microscope 100 be configured so that the wavelength of the pulsed light emitted from the light source unit 2 is between 1200 nm through 1350 nm, after which the internal transmittance suddenly drops, and the internal transmittance of the immersion liquid be 95%/nm or more with respect to the wavelength of the pulsed light. Also in this case, deeper portions of the sample can be observed because the absorption of light by both the immersion liquid and the water in the sample can be suppressed even when light of a long wavelength is used.

### Embodiment 2

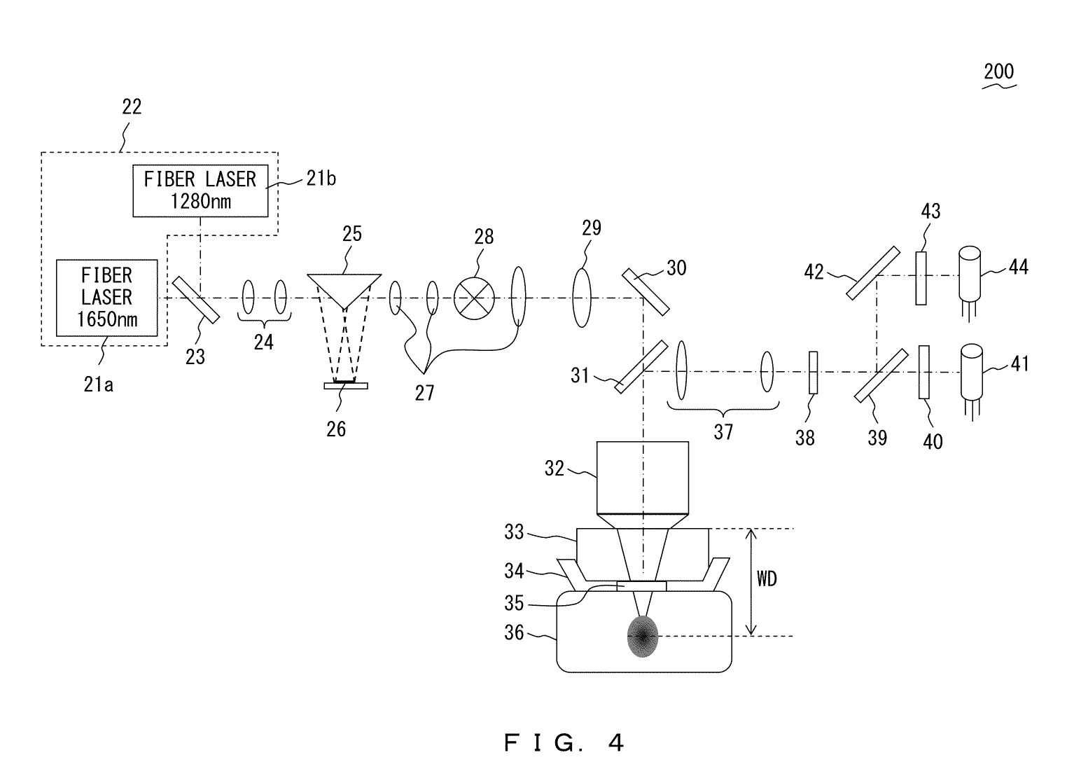

FIG. 4 is an explanatory view of the two-photon excitation microscope according to the present embodiment.

A two-photon excitation microscope 200 as a type of nonlinear optical microscope exemplified in FIG. 4 includes: a light source unit 22 formed by a fiber laser 21a for emitting laser light of a wavelength of 1280 nm and a fiber laser 21b for emitting laser light of a wavelength of 1650 nm; a dichroic mirror 23 for reflecting light of a wavelength of 1280 nm and passing light of a wavelength of 1650 nm; a beam expander 24 for expanding a beam diameter; a prism 25; a phase modulation SLM (spatial light modulator) 26 for modulating the phase of laser light at the pupil conjugate position of an objective 32 and controlling the wave front; a pupil relay lens 27; a galvanometer mirror 28 for scanning a sample 36; a tube lens 29; a mirror 30; a dichroic mirror 31 for passing laser light for excitation of the sample 36 and reflecting the fluorescence generated from the sample 36; an objective 32 for emitting the laser light emitted from the light source unit 22 to the sample 36; a silicone oil 33 as an immersion liquid filling the space between the sample 36 and the objective 32; and an immersion liquid holding unit 34 of which a portion is formed by a cover glass 35.

As exemplified in FIG. 4, the two-photon excitation microscope 200 includes on the reflecting optical path of the dichroic mirror 31 for reflecting the fluorescence a relay lens 37, an IR cut filter 38, a dichroic mirror 39, a fluorescence detecting filter 40, a PMT 41, a mirror 42, a fluorescence detecting filter 43, and a PMT 44.

As the phase modulation SLM 26, a reflecting liquid crystal phase modulator, a reflecting mirror phase modulator for generating an optical path length difference by driving a mirror, a deformable mirror, and the like can be used. In FIG. 4, the phase modulation SLM 26 as a reflecting device is exemplified, but the phase modulation SLM 26 is not limited to a reflecting device. For example, a transmission device such as a transmission liquid crystal phase modulator or the like can be used. In addition, the galvanometer mirror 28 can be replaced with an acoustic optical deflector or the like as an XY scanner for scanning the sample 36.

The fiber laser 21a and the fiber laser 21b emit pulsed light having a pulse width on the subpicosecond order. That is, the light source unit 22 can selectively or simultaneously emit laser light of a wavelength of 1280 nm or 1650 nm. The dichroic mirror 23 leads to the beam expander 24 the laser light emitted from the fiber laser 21a and the fiber laser 21b.

The beam expander 24 expands the beam diameter of the laser light and emits the light as a parallel luminous flux to the prism 25. The prism 25 reflects the laser light emitted from the beam expander 24 to the phase modulation SLM 26, and reflects the laser light modulated by the phase modulation SLM 26 to the pupil relay lens 27.

The phase modulation SLM 26 is arranged at the pupil conjugate position of the objective 32, and controls the wave front of the laser light, thereby moving the condensing position of the laser light to any position in the X- and Y-axis directions orthogonal to the optical axis of the objective 32. In addition, the condensing position of the laser light can also be moved to any position in the z-axis direction parallel to the optical axis of the objective 32. Furthermore, the spherical aberration at the condensing position of the laser light can be appropriately corrected. That is, the phase modulation SLM 26 functions as a spherical aberration correction mechanism, and can correct the spherical aberration caused by the inconsistency of refractive index between the medium in contact with the sample 36 and the sample 36, and can correct the spherical aberration caused by a change in observation depth.

The galvanometer mirror 28 is arranged at the pupil conjugate position of the objective 32, and deflects the laser light received through the pupil relay lens 27, thereby changing the tilt with respect to the optical axis of the luminous flux entering the objective 32, thus scanning the sample 36.

The objective 32 has a working distance of 2 mm or more. Furthermore, it is preferable that the aberration has been appropriately corrected with respect to the wavelength band of 1200 nm or more, that is, the wavelength band of 1280 nm and 1650 nm to be concrete. In a wavelength band in which the aberration is not appropriately corrected, the SLM 26 can correct the spherical aberration.

The silicone oil 33 has a refractive index of about 1.4, which is higher than the refractive index (1.33) of pure water, and has a higher internal transmittance than pure water for the wavelength of the laser light (pulsed light) emitted from the light source unit 22 as illustrated in FIG. 2.

In FIG. 4, the silicone oil 33 is exemplified as an immersion liquid, but in the present embodiment as in embodiment 1, an immersion liquid used for a water-immersion microscope, including perfluoropolyether, which has a functional group commercially available as an immersion liquid, can be used.

The immersion liquid holding unit 34 is a member for holding an immersion liquid (silicone oil 33) between the sample 36 and the objective 32, and is dish-shaped, as exemplified in FIG. 4. The immersion liquid is normally held between a sample and an objective by surface tension. However, since the objective 32 of the present embodiment has a long working distance, 2 mm or more, it is necessary to hold a relatively large volume of immersion liquid between the objective 32 and the sample 36. Therefore, it is preferable to use the immersion liquid holding unit 34 to stably hold the immersion liquid. The cover glass 35, which has a high transmittance, is installed at the center of the immersion liquid holding unit 34 where light passes so that the immersion liquid holding unit 34 cannot interfere with the emission of light to the sample 36.

The IR cut filter 38 is used to prevent the laser light emitted from the light source unit 22 from entering the PMT (PMT 41, PMT 44), and to cut off the light of the wavelength in the infrared area.

The dichroic mirror 39 reflects the fluorescence excited by the laser light of 1280 nm, and passes the fluorescence excited by the laser light of 1650 nm, and the fluorescence detecting filter 40 passes the fluorescence excited by the laser light of 1650 nm and the fluorescence detecting filter 43 passes the fluorescence excited by the laser light of 1280 nm.

The PMT 41 and the PMT 44 are arranged near a position optically conjugate to the pupil position of the objective 32. In the two-photon excitation microscope 200, the relay lens 37 projects the pupil of the objective 32 near the PMT 41 and the PMT 44, thereby detecting the fluorescence caused in any area of the sample 36 by scanning the sample 36.

With the two-photon excitation microscope 200 configured as described above, as with the two-photon excitation microscope 100, the scattering of light can be suppressed using light of a long wavelength. In addition, using an immersion liquid having a higher internal transmittance than pure water with respect to the light source wavelength and having a large refractive index, the absorption of light caused from the objective 32 to the sample 36 can be suppressed. Therefore, the two-photon excitation microscope 200 according to the present embodiment can observe a deeper portion of a sample than the conventional microscope, as with the two-photon excitation microscope 100 according to embodiment 1.

In addition, the two-photon excitation microscope 200 according to the present embodiment uses laser light of a wavelength of 1280 nm and 1650 nm. As illustrated in FIG. 2, a wavelength of 1280 nm is a wavelength immediately before the internal transmittance of pure water suddenly drops, and a wavelength of 1650 nm is a wavelength near the maximum point of the internal transmittance of pure water. Therefore, the two-photon excitation microscope 200 can suppress the absorption of light by the water in the sample 36 with respect to the light of these wavelengths. Accordingly, the two-photon excitation microscope 200 according to the present embodiment can observe a further deeper portion of a sample because the absorption of light by both the immersion liquid and the water in the sample can be suppressed.

What is claimed is:

1. A nonlinear optical microscope, comprising:
a light source unit emitting pulsed light having a wavelength of 1200 nm or more and having a pulse width of several tens through several hundreds of femtoseconds;
an objective emitting the pulsed light from the light source unit to a sample and having a working distance of 2 mm or more; and
an immersion liquid filling a space between the sample and the objective and having an internal transmittance higher than an internal transmittance of pure water with respect to the wavelength of the pulsed light emitted from the light source unit.

2. The microscope according to claim 1, wherein the wavelength of the pulsed light ranges from 1600 nm to 1750 nm.

3. The microscope according to claim 2, wherein
the internal transmittance of the immersion liquid is 80%/mm or more for the wavelength of the pulsed light.

4. The microscope according to claim 1, wherein
the wavelength of the pulsed light ranges from 1200 nm to 1350 nm.

5. The microscope according to claim 4, wherein
the internal transmittance of the immersion liquid is 95%/mm or more for the wavelength of the pulsed light.

6. The microscope according to claim 1, wherein
the wavelength of the pulsed light ranges from 1550 nm to 1850 nm.

7. The microscope according to claim 3, wherein
the refractive index of the immersion liquid is higher than 1.38.

8. The microscope according to claim 7, wherein
the immersion liquid is silicone.

9. The microscope according to claim 3, further comprising
a spherical aberration correction mechanism for correcting spherical aberration.

10. The microscope according to claim 9, wherein
the spherical aberration correction mechanism is a correction ring of the objective.

11. The microscope according to claim 3, wherein
the light source unit comprises:
a light source; and
an optical parametric oscillator for converting the wavelength of the light emitted from the light source.

12. The microscope according to claim 3, wherein
the light source unit is a fiber laser.

13. The microscope according to claim 3, further comprising
an immersion liquid holding unit for holding the immersion liquid between the objective and the sample.
